(19) United States
(12) Patent Application Publication
(10) Pub. No.: US 2012/0263635 A1
(43) Pub. Date: Oct. 18, 2012

(54) PROCESS AND APPARATUS FOR REMOVAL OF VOLATILE ORGANIC COMPOUNDS FROM A GAS STREAM

(75) Inventors: David John Cork, Medowie (AU); Andrew James Cork, Waratah (AU)

(73) Assignee: CORKY'S MANAGEMENT SERVICES PTY LTD, Mayfield, New South Wales (AU)

(21) Appl. No.: 13/496,821

(22) PCT Filed: Sep. 17, 2010
(86) PCT No.: PCT/AU10/01217

§ 371 Date: Jul. 2, 2012

(30) Foreign Application Priority Data
Sep. 18, 2009 (AU) 2009904574

(51) Int. Cl. B01D 53/76; B01D 53/44

(52) U.S. Cl. 423/245.3; 422/173; 422/117

(57) ABSTRACT

A process and/or apparatus for removing one or more volatile organic compounds from a gas stream. The apparatus including: a first conduit containing thermal media forming a pre heating zone, wherein the pre heating zone increases the temperature of the gas stream via heat transfer; and, a combustion chamber forming a combustion zone wherein the combustion chamber is in fluid connection with the first conduit. The combustion zone is at a temperature sufficient whereby at least one of the volatile organic compounds in the gas stream combusts. The process including the steps of passing a gas stream through a pre heating zone wherein the pre heating zone is composed of thermal media contained within a first conduit; and, introducing the gas stream exiting the pre heating zone into a combustion zone wherein at least one of the volatile organic compounds included in the gas stream is combusted.

The present invention relates to a method and apparatus for the removal of volatile organic compounds from a gas stream and in particular to the removal of methane from underground mine ventilation air.

### BACKGROUND

Methane is a potent greenhouse gas, with around 21 times the global warming potential of carbon dioxide. Methane will burn in air when the air is above 595° C. and the methane concentration is between 5 and 15%.

Methane may be released from underground coal mines as part of the ventilation air and is known as Ventilation Air Methane (VAM). The global emissions of methane from mine ventilation air are said to be equivalent to 200 million tonnes of carbon dioxide. The mitigation of methane from the VAM is very challenging due to its high volume flow rate and low methane concentration.

The volume of mine ventilation air is typically very large. Ventilation air exhaust streams typically range from 150 to 500 m³/s.

VAM typically has a concentration level of less than 1% volume. However the daily average VAM can vary between 0.0% and 1.5% volume within a month. Thus the combustion characteristics of VAM are highly variable. The flammability range demonstrates that the typical concentrations of methane in VAM are well below the lower flammability limit, which is 5.0% volume methane in air.

Another source of methane gas is often associated with old landfill sites which can provide gas stream flows that are just as variable and with similar methane concentration to VAM.

In addition VAM is often associated with moist dust. This dust is a mixture of carbonaceous and limestone powders. The limestone is added to the mine to reduce the risk of coal dust explosion.

Although the concentration of VAM is well below the explosive limit, there have been some attempts to oxidise ultra low concentration methane/air mixtures. One example is a flow reversal oxidiser.

However, there have been numerous problems that have been found with flow reversal oxidisers that have been trialled to date in addition to their substantial capital cost. The existence of the moist limestone dust in the VAM significantly contributes to the degradation of the flow reversal oxidisers as at high temperatures the limestone fluxes acidic refractory which leads to the glazing of heat exchange thermal media and subsequent blocking and melting of this media. In addition, the current designs for the flow reversal oxidisers require flame arresters to prevent flashback into the VAM feed inlet. These flame arresters often become blocked by the limestone dust and also provide a high pressure drop across the flow path of the VAM through the flow reversal oxidisers which then leads to a significantly higher power load for the fans pushing the VAM through the apparatus.

Another issue is that due to the variable nature of the methane concentration in the VAM caused by normal mine operation, mine maintenance and long-wall changes, there is an ongoing requirement to add higher purity methane to maintain the temperature necessary for oxidation within the flow reversal oxidiser when the methane concentration drops to negligible amounts. Furthermore, these devices have to reverse the flow of the VAM through the device at regular intervals which means there is a significant amount of idle time.

Accordingly the present invention seeks to provide an apparatus and/or a process for removal of organic volatile components from a gas stream that overcomes at least some of the issues outlined above.

### SUMMARY

According to another aspect the present invention provides an apparatus for removing one or more volatile organic compounds from a gas stream, the apparatus including:
a first conduit containing thermal media forming a pre heating zone, the first conduit including an inlet at one end for introducing the gas stream into the pre heating zone and an outlet at the other end of the first conduit, wherein the pre heating zone increases the temperature of the gas stream via heat transfer; and,
a combustion chamber forming a combustion zone wherein the combustion chamber is in fluid connection with the outlet of the first conduit for receiving the gas stream exiting the pre heating zone,
wherein the combustion zone is at a temperature sufficient whereby at least one of the volatile organic compounds in the gas stream combusts.

In one form, the apparatus further includes a second conduit containing thermal media forming a heat retention zone including an inlet at one end for receiving the gas stream after passing through the combustion zone, wherein the gas stream received by the inlet of the second conduit increases the temperature of the heat retention zone via heat transfer, the second conduit further including an outlet at the other end.

In one form, the pre heating zone containing the thermal media is a sufficient length whereby the pre heating zone provides a flame path barrier between the combustion zone and the source of the gas stream entering the pre heating zone. In one form, the pre heating zone is at least 2 m in length, and in another form, the pre heating zone is at least 3 in in length. In one form, the length of the heat retention zone containing the thermal media is the same or substantially the same length as the pre heating zone.

In one form, the thermal media is composed of a material with a bulk density greater than 1.5 t/m³. In another form, the thermal media is composed of a material with a bulk density greater than 2.0 t/m³.

In one form, the thermal media is composed of a material with a sufficient void space whereby there is no substantial drop in pressure between the gas stream entering the pre heating zone and the gas stream entering the combustion zone. In one form, the thermal media is composed of a material with a void space of greater than 20% volume. In another form, the thermal media is composed of a material with a void space of greater than 30% volume. In another form, the thermal media is composed of a material with a void space of greater than 50% volume

In one form, the thermal media is composed of a material that has a refractory softening temperature of greater than 1400° C., and in another form, the thermal media is composed of a material that has a refractory softening temperature of greater than 1500° C.

In one form, the thermal media is composed of a material that includes Al₂O₃. In another form, the thermal media is composed of a material that includes at least 30% weight Al₂O₃. In a further form, the thermal media is composed of a material that includes at least 38% weight Al₂O₃.

In one form, the thermal media within the pre heating zone, and/or the heat retention zone, and adjacent the combustion zone are composed of a material that includes at least 44% weight Al₂O₃, and, in another form, the thermal media within the pre heating zone and/or the heat retention zone, and adjacent the combustion zone are composed of a material that includes at least 48% weight Al₂O₃.

In one form, at least 10% of the thermal media within the pre heating zone and/or the heat retention zone that is nearest the combustion zone is composed of a material that includes at least 44% weight Al₂O₃, and in another form, at least 48% weight Al₂O₃. In a further form, at least 20% of the thermal media within the pre heating zone and/or the heat retention zone that is nearest the combustion zone is composed of a material that includes at least 44% weight Al₂O₃, and in another form, at least 48% weight Al₂O₃.

In one form, the thermal media is composed of a plurality of chequer bricks that are stacked along the length of the pre heating zone and/or heat retention zone. In this form, the chequer bricks may include passages passing through the bricks which provide the chequer bricks with a pathway for the gas stream to pass through as well as provide the void space for the thermal media.

In one form, the pre heating zone may be initially heated by passing a hot gas stream through the pre heating zone to heat the pre heating zone to a desired temperature before introducing the gas stream including the volatile organic compounds. In one form, the hot gas stream may be a waste heat stream from any available source such as for example a gas engine exhaust. According to this form, the hot gas stream may also initially heat the combustion zone and/or the heat retention zone.

In one form, the combustion zone may include an additional heat source to bring the combustion zone to the desired temperature where the volatile inorganic compound in the gas stream begins to combust. In one form, the additional heat source may be provided by direct contact with a waste heat source such as for example a gas engine exhaust. In another form, the additional heat source may be provided by introducing a combustible gas stream into the combustion zone and igniting the combustible gas. In one form, a low calorific gas may be provided which may be ignited and combusted within the combustion zone by a gas gun. In another form, a high calorific gas may be provided into the combustion chamber which is ignited and burnt by a gas burner. In one form, any additional heat provided to the combustion zone may be provided by more than one source.

In one form, the combustion zone may be heated or cooled by indirect heat exchange. According to this form, the combustion chamber includes one or more conduits which make up a part of a separate circuit containing a heat exchange medium wherein heat may be exchanged indirectly between the heat exchange medium within the conduits and the combustion zone within the combustion chamber. According to this form, the temperature within the combustion zone may be controlled by adjusting the level of indirect heat exchange.

In one form, the combustion zone provides heat to the heat exchange medium which may be distributed for use by the separate circuit containing the heat exchange medium. The use of the heat from the combustion zone can be for any suitable purpose such as for example a heat source for producing electricity or for use in thermal desalination processes.

In one form, at least part of the heat retained in the heat retention zone may be recovered by indirect heat exchange with a separate circuit of heat exchange medium passing through the heat retention zone. In one form, the separate circuit of heat exchange medium passes through the heat retention zone adjacent the outlet to the second conduit.

In another form, the combustion chamber includes one or more vents moveable between a closed position and an open position wherein the temperature within the combustion zone may be reduced by opening the one or more vents and allowing heat to escape from the combustion zone through the one or more vents.

In one form, before the gas stream including the volatile organic compound is introduced into the pre heating zone, the gas stream passes through a conditioning duct where the gas stream may be partially heated and/or wherein particulate matter may be removed from the gas stream. In one form, the conditioning duct is aligned horizontally such that any particulate matter that falls out of the gas stream falls to the floor of the conditioning duct.

In one form, the conditioning duct is at least 10 metres in length. In a further form, the conditioning duct is at least 15 meters in length. In yet a further form, the conditioning duct is at least 20 metres in length. In one form the conditioning duct may be composed of concrete and/or light weight insulated sandwich panel.

In one form, the conditioning duct includes one or more safety doors which are able to move between an open and closed position wherein the gas stream passing along the conditioning duct is able to be expelled to atmosphere when the one or more safety doors is in the open position. In one form, the one or more safety doors opens when a lower explosive limit (LEL) value for at least one of the volatile organic chemicals is detected in the gas stream passing through the conditioning duct.

In one form the conditioning duct may be heated by indirect heat exchange which in turn provides heat to the gas stream passing through the conditioning duct. In one form, the conditioning duct may be heated by indirect heat exchange. In one form, the indirect heat exchange may be provided by heat taken from the combustion zone via the separate circuit including the heat exchange medium.

In one form, the apparatus further includes a valve arrangement capable of changing the direction of the flow of the gas stream through the apparatus between a first flow direction and a second flow direction whereby in the first flow direction the valve arrangement introduces the gas stream including the one or more volatile organic compounds into the inlet of the first conduit; and whereby in the second flow direction the gas stream including the one or more volatile organic compounds is introduced into the second conduit in which the heat retention zone of the second conduit becomes the pre heating zone of the apparatus and the pre heating zone of the first conduit becomes the heat retention zone of the apparatus.

In one form, the valve arrangement redirects the flow of the gas stream between the first flow direction and the second flow direction once the heat retention zone reaches a predetermined temperature condition resulting from the heat provided from the gas stream passing through the heat retention zone after the combustion zone, and/or after a predetermined time interval.

In one form, the redirection of the gas stream between the first flow direction and the second flow direction is conducted cyclically.

According to another aspect the present invention provides a valve arrangement for use with an apparatus for removing one or more volatile organic compounds from a gas stream, the valve arrangement including two directing chambers with a first directing chamber in fluid communication with the inlet of a first conduit of the apparatus, and a second directing chamber in fluid communication with the outlet of a second conduit of the apparatus, wherein each of the directing chambers includes an inlet for receiving the gas stream including the one or more volatile organic compounds, and an outlet for receiving the gas stream after the at least one volatile organic compounds has been combusted in the combustion zone, wherein each of the inlets and outlets of the first and second directing chambers are individually moveable between an open and a closed state by a respective valve closure. In one form, each of the valve closures is a gate valve.

In one form, during the first flow direction the inlet of the first directing chamber is in an open state and the outlet of the first directing chamber is in a closed state, and the inlet of the second directing chamber is in a closed state and the outlet of the second directing chamber is in an open state. This provides that during the first flow direction, the gas stream containing the one or more volatile organic compounds is received by the inlet of the of the first directing chamber which then flows into the inlet of the first conduit passing though the apparatus and exiting through outlet of the second conduit into the second directing chamber where the gas stream is directed out of the outlet of the second directing chamber.

In one form, during the second flow direction the inlet of the first directing chamber is in a closed state and the outlet of the first directing chamber is in a open state, and the inlet of the second directing chamber is in an open state and the outlet of the second directing chamber is in a closed state. This provides that during the second flow direction, the gas stream containing the one or more volatile organic compounds is received by the inlet of the of the second directing chamber which then flows into the outlet of the second conduit passing though the apparatus and exiting through the inlet of the first conduit into the first directing chamber where the gas stream is directed out of the outlet of the first directing chamber.

In one form, once the heat retention zone reaches a predetermined temperature condition resulting from the heat provided from the gas stream passing through the heat retention zone after the combustion zone, and/or after a predetermined time interval, the gas stream flow is redirected whereby the gas stream including the volatile organic compound is introduced into the heat retention zone via the outlet of the second conduit where the gas stream is preheated as it passes through the thermal medium contained in the heat retention zone before being introduced into the combustion zone. In this form, once the gas stream flow is redirected, the heat retention zone becomes the pre heating zone and the pre heating zone becomes the heat retention zone. According to this form, the redirection of the gas stream including the volatile organic compound may be provided in a cyclic fashion wherein each time the heat retention zone reaches a predetermined temperature condition, and/or after a predetermined time interval, the gas stream may be redirected. In this form, the pre heating zone and the heat retention zone form two alternating heating zones of a regenerative burner.

In one form, the first conduit including the pre heating zone and the second conduit including the heat retention zone are arranged side by side with the combustion chamber at one end in fluid communication with the outlet of the first conduit and the inlet of the second conduit.

In one form, one or more apparatus may be arranged together to form a battery of apparatuses for removing volatile organic compounds from a gas stream. According to this form, the pre heating zones and the heat retention zones of the apparatuses may be arranged side by side to increase the thermal efficiency of the battery of apparatuses.

In one form, the gas stream including the volatile organic compound is a mine ventilation gas stream. In one form, the mine ventilation gas stream is from a coal mine and the volatile organic compound is methane. In this form, the methane concentration in the gas stream is less than 5% volume. In a further form, the methane concentration in the gas stream may vary and may be anywhere between 0.0% and 3% volume.

According to another aspect the present invention provides a process for removing one or more volatile organic compounds from a gas stream, the process including the following steps:
a. passing the gas stream through a pre heating zone wherein the pre heating zone is composed of thermal media contained within a first conduit; and,
b. introducing the gas stream exiting the pre heating zone into a combustion zone wherein at least one of the volatile organic compounds included in the gas stream is combusted.

In one form, the gas stream exiting the combustion zone in step b. passes through a heat retention zone wherein the heat retention zone is composed of thermal media contained within a second conduit.

### BRIEF DESCRIPTION OF THE FIGURES

The present invention will become better understood from the following detailed description of preferred but non-limiting embodiments thereof, described in connection with the accompanying figures, wherein:

FIG. 1 is an elevation cross section of an underground mine installation with a ventilation system providing a gas stream that is being directed to an apparatus in accordance with certain embodiments;

FIG. 2 is a schematic diagram of an elevation cross section of an apparatus in accordance with certain embodiments;

FIG. 3 is a schematic diagram of two variants of chequer bricks that may be used in accordance with certain embodiments;

FIG. 4 is a detailed elevation cross section of the upper portion of the combustion chamber and vent arrangement of an apparatus in accordance with certain embodiments;

FIG. 5 is a schematic diagram of various arrangements of the apparatus in accordance with certain embodiments;

FIG. 6 is a plan schematic diagram showing an installation environment for the apparatus of the present invention including a conditioning duct in accordance with certain embodiments;

FIG. 7 is a plan schematic diagram showing an installation environment for the apparatus of the present invention including a conditioning duct in accordance with certain embodiments;

FIG. 8 is a process flow diagram outlining the incorporation of the apparatus within a coal mine site in accordance with certain embodiments;

FIG. 9 is an example of pre-fabricated panels from which the apparatus may be constructed from in accordance with certain embodiments; and,

FIG. 10 is a schematic diagram of a valve arrangement in accordance with certain embodiments.

### DETAILED DESCRIPTION AND EMBODIMENTS

According to one embodiment, the present invention relates to a process and/or apparatus for combustion of low concentration amounts of volatile organic compounds in a gas stream. In particular, certain embodiments relate to a process and/or apparatus for the removal of methane from a gas stream such as for example a gas stream issuing from a mine ventilation system or from a land fill site. The process and/or apparatus makes use of regenerative heating and provides a means of removing the methane from mine ventilation air including a methane concentration of less than 5% volume and typically less than 2% volume and which concentration can vary considerably over time any where between 0.0% and 2.0% on regular basis.

The combustion of methane does not increase gas volume which can be seen from the following equation where there are three gas volumes on the left and three gas volumes on the right hand side:

CH₄+20₂→CO₂+2H₂0+heat

However, the heat liberated can cause some increase in gas volume. Therefore, if one controls temperature then pressure will also be controlled.

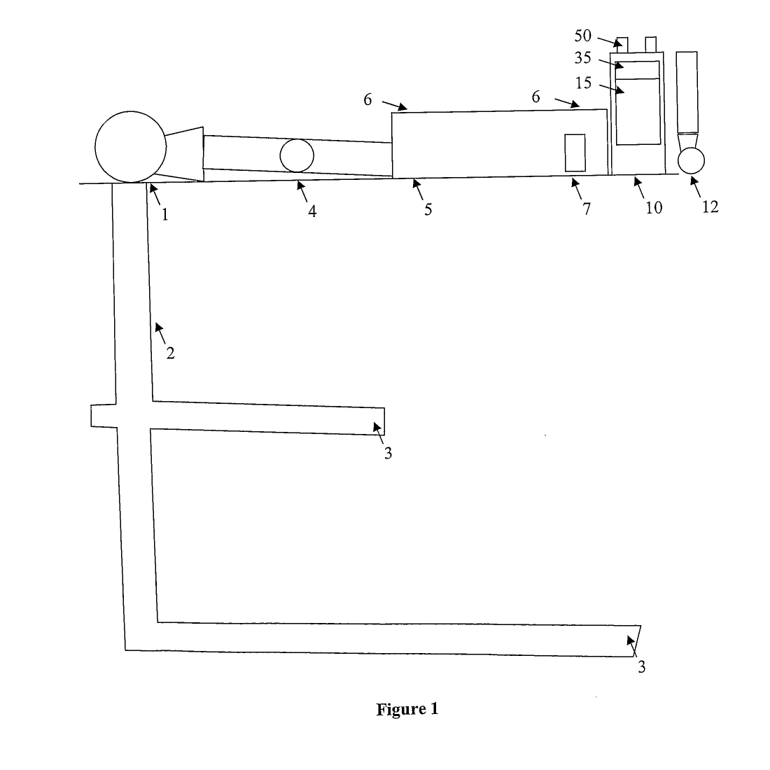

In FIG. 1 there is shown an elevation cross section of an underground coal mine installation with a ventilation system including a large mine fan 1 which sucks ventilation air up the mine shaft 2 from the mine working areas 3. The air that is sucked up by the mine fan 1 also includes any methane which emanates from the underground mine installation which typically provides a gas stream of ventilation air with a low concentration of methane as well as a highly variable methane concentration of about 1% volume on average. However this can be as high as about 5 to 10% volume and as low as 0% volume depending on the amount of methane present in the coal seam being mined. The methane within the gas stream is typically referred to as VAM being Ventilation Air Methane.

As can be seen from FIG. 1, the mine fan 1 pushes the VAM to a conditioning duct 5 via a smaller diameter duct. The smaller diameter duct has a by-pass 4 which is put in place as a safety measure to separate the apparatus 10 from the mine installation and in particular the VAM source. The by-pass 4 is set in a closed position during normal operation and only operates redirecting the VAM away from the conditioning duct 5 and apparatus 10 when the methane within the VAM reaches a preset methane concentration. The preset methane concentration could for example be a fraction of the Lower Explosive Limit (LEL).

As a further safety feature, the conditioning duct 5 has a frangible roof 6 that is able to separate from the main duct structure. As such, should the methane have a concentration above the Lower Explosive Limit (LEL) then the resulting pressure wave will separate the apparatus 10 from the source of the VAM. For example, the frangible roof 6 of the conditioning duct 5 will separate when the pressure in the conditioning duct 5 reaches about 5 kPa. In addition, and to minimise the risk of unnecessarily destroying the conditioning duct 5, there may also be included doors 7 that open at a set percentage of LEL and provide an emergency by pass and acceptable vent area.

The gas stream is passed through a conditioning duct 5 prior to entering the apparatus 10 for two main reasons. Firstly, the conditioning duct provides an amount of heat to the VAM to a degree where water aerosols within the gas stream are converted into water vapour. The conditioning duct 5 is heated by any heat, or preferably waste heat source, which may be passed through the structure of the conditioning duct 5 via an indirect heat transfer circuit which in turn heats the VAM passing through.

Secondly, the conditioning duct 5 also acts to de-agglomerate mud particles, held together by water, into particle too small to cross a slip stream. That is to break, say a 30 micron particle, into many sub 10 micron particles.

The conditioning duct also provides a significant separation distance from the source of the VAM, i.e. the mine shaft ventilation fan 1, from the apparatus 10 for removing the VAM. Combined with the various safety features outlined above, the conditioning duct can be separated from the apparatus at any time such that an explosive or potentially dangerous gas mixture is not introduced into the combustion zone of the apparatus. This feature is one reason why it is not necessary to include flame arresters in the construction of the apparatus 10. This provides that the apparatus can operate without significant pressure drop which is typically found when flame arresters are required which in turn means the fans driving the stream of VAM can be far less expensive and less energy consuming.

Once the VAM passes through the conditioning duct 5 it then enters the apparatus 10 which contains thermal media in the form of chequer bricks 15 and a combustion chamber 35 in which the methane within the VAM combusts thereby removing the methane concentration from the gas stream from the mine shaft ventilation system. The thermal media 15 is included in a sufficient length from the source of the VAM in the conditioning duct 5 such that the thermal media provide a flame barrier from the combustion chamber 35 and the VAM entering from the conditioning duct. The length of the bed of thermal media before the combustion chamber is a further design feature which enables the apparatus to operate without flame arresters.

If the temperature within the combustion chamber 35 becomes too hot, relief flaps 50 expel excess heat thereby controlling the temperature within the apparatus 10 and maintaining the temperature within the combustion chamber does not exceed the operating temperature of the thermal media 15. The treated VAM leaves the apparatus via an induce draft fan 12 and a stack.

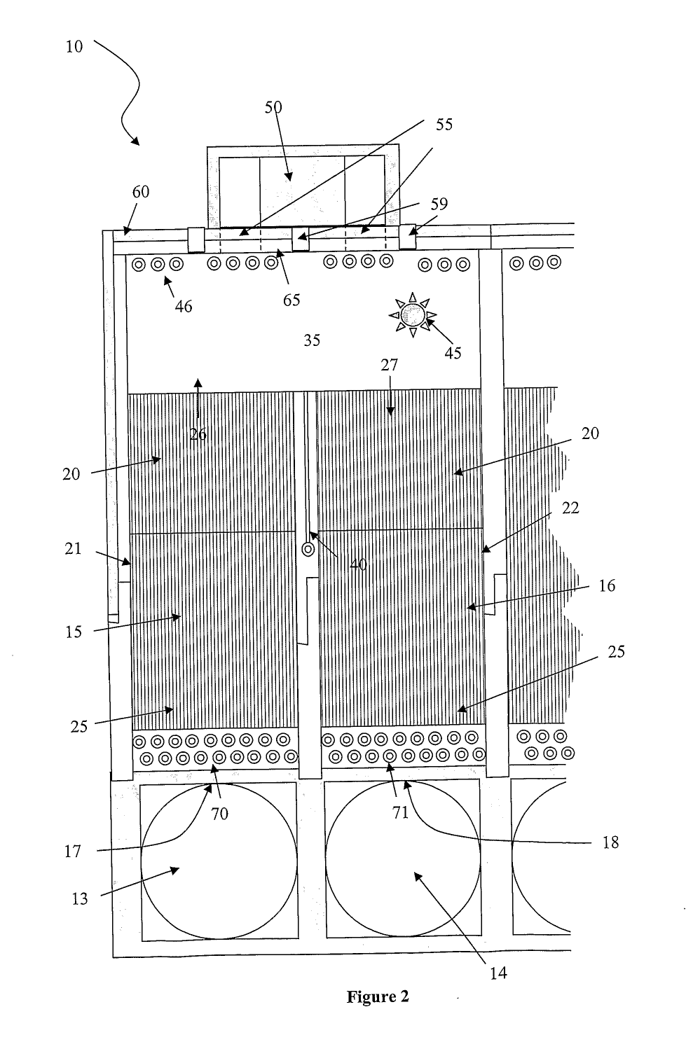

Referring to FIG. 2 there is shown an apparatus 10 in accordance with an embodiment of the present invention. The apparatus includes an inlet 17 which leads into a bed of thermal media 15 contained within a first conduit 21. The outlet 26 of the first conduit 21 leads into a combustion chamber 35 which in turn leads into the inlet 27 of the second conduit 22 which also contains a bed of thermal media 16. The bed of thermal media 16 in the second conduit 22 then leads to the outlet of the second conduit 18.

In this embodiment, the bed of thermal media 15 is made up of chequer bricks which are stacked in a vertical fashion within the first and second conduits 21, 22. The bed of thermal media 15, 16 forms the pre heating and heat retention zones of the apparatus 10 during operation. The chequer bricks in this embodiment have greater than 40% void space which therefore allows a gas stream to pass through the bed of thermal media 15 without a significant pressure drop.

In addition, the bed of thermal media 15, 16 is of a sufficient length whereby the bed of thermal media 15, 16 making up the pre heating zone and the heat retention zone provides a flame path barrier between the combustion zone within the combustion chamber 35 and the inlet 17 and outlet 18 of the first and second conduits 21 and 22. In this embodiment the bed of thermal media 15, 16 within the first and second conduits 21, 22 is 3.0 metres in length and is arranged in a vertical fashion with the combustion chamber at the top of the apparatus and each of the first 21 and second 22 conduits separated by a central wall.

Each bed of thermal media 15, 16 in the first and second conduits 21, 22 are made up of two sections 25, 20 which include different types of chequer bricks. The first section 25 is nearest the inlet 17 of the first conduit 21 and the outlet 18 of the second conduit 22 and makes up approximately 75% of the bed of thermal media 15, 16. The first section 25 of chequer bricks includes chequer bricks composed of a high density fire clay which includes between 38 to 44% Al₂O₃. Such a high density fire clay has a very high thermal mass which provides that these chequer bricks are very good at absorbing and retaining heat from a gas stream passing through them. These bricks are very robust with respect to thermal cycling.

The second section 20 of chequer bricks is adjacent the combustion zone 35 in both the first and second conduits 21, 22 and makes up approximately 25% of the bed of thermal media 15, 16. The second section 25 of chequer bricks includes chequer bricks that are composed of high alumina bricks with at least 48% Al₂O₃. A high alumina brick is used in this second section 25, adjacent the combustion chamber, due to its resistance to fluxing and thermal deformation. These bricks have a very high thermal mass and are very good at storing high temperature heat.

The combustion chamber 35 of the apparatus 10 contains the combustion zone where a volatile organic compound will combust once the temperature is sufficiently high. The combustion chamber 35 includes additional means to provide additional sources of heat which may be used to increase the temperature of the combustion zone during the operation of the apparatus, such as for example during start-up in order to heat the combustion chamber to the required operation temperature. In addition, in the event the concentration of the volatile organic compound, such as methane, drops to low concentration levels, then additional heat may be needed in order to raise the temperature of the combustion zone back to a desired operational temperature, such as about 595° C. for methane combustion.

A gas gun 40 may be configured to fire low quality fuel gas into the combustion chamber 35. The gas gun in this embodiment uses a low, or high, calorific value gas in order to provide some additional heat within the combustion zone. Importantly the gas gun allows low and variable CV fuel to be used where such fuel would be unstable in a conventional packaged burner. Low and variable CV methane is commonly available around coal mines where a high methane gas may not always be available.

In addition a packaged burner 45 also located within the combustion chamber 35 may be fired when more heat is required in the combustion zone and the burner may be fed a higher calorific value gas to provide such heat.

On high methane or VOC concentration operation the combustion chamber also includes additional steam tubes 46 that are closed conduits that pass through the combustion chamber 35. The steam tubes 46 are formed of conduits which make up a part of a separate circuit containing a heat exchange medium, in this case steam, wherein heat may be exchanged indirectly between the steam tubes 46 and the combustion zone within the combustion chamber 35. In this way, the temperature within the combustion zone may be controlled by adjusting the level of indirect heat exchange and the amount of heat that is taken out of the combustion zone by the steam within the steam tubes 46.

Such temperature control of the combustion zone is quite advantageous, particularly when dealing with a gas stream that has varying concentrations of the volatile organic compound. If we take the example using VAM, the concentration of the methane could peak around 2-3% methane from time to time which would spike the temperature within the combustion zone of the apparatus. If the combustion zone reaches temperatures in excess of 1200° C. this can cause problems for the structural integrity of the heat exchange media, particularly if there is limestone dust (CaO) present within the VAM. At temperatures above 1200° C. you start to get solid state migration of CaO into the heat exchange media which causes fluxing and degradation of the heat exchange media. As such, by controlling the temperature within the combustion zone to below 1200° C. and preferably below 1150° C., the integrity of the heat exchange media can be maintained.

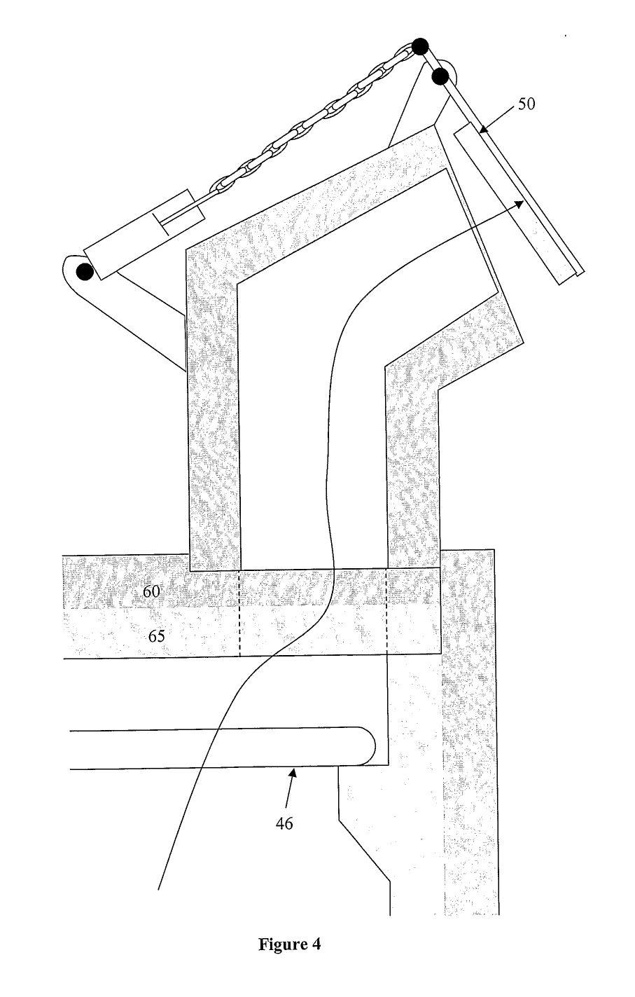

A further mechanism for controlling the temperature of the combustion zone within the combustion chamber 35 of the apparatus 10 is by including a vent 50 located on the top of the apparatus 10 which is in fluid communication via venting ports 55 which direct heat away from the combustion chamber 35 out through the vent 50 when it is in an open state (see also detail provided by FIG. 4 showing an alternative arrangement for the passage of heat with the directional arrow). By moving the vent 50 between a closed position and open position it is possible to control the level of heat escaping from the combustion chamber 35 and therefore the temperature within the combustion zone.

Referring to FIG. 4, a vent 50 assembly is shown in the form of a flap which is hinged to be able to move between a closed position covering the vent opening and an open position where heat is able to escape from the combustion chamber of the apparatus 10.

As the temperature rises in the combustion chamber 35, the pressure on the flap 50 moves from a slight negative gauge to a slight positive gauge pressure. During hot operation within in the combustion chamber such as when the methane concentration within the VAM increases, you may wish to expel hot air through the open vent 50 to reduce the temperature within the combustion chamber 35. The pressure relief flap is opened by hydraulics which then allows hot air to be bled from the combustion chamber. This bleed air can no longer preheat the thermal media 15, 16 and so the combustion chamber 35 slowly cools to the point when the relief flaps are closed. Separate to temperature control, these flaps can open at low pressure excursions so to avoid over pressure in the within the apparatus 10. As such, the vents 50 act as a safety device as well and assisting as a temperature control mechanism.

The combustion zone 35 of the apparatus 10 is constructed with high density insulation 65 making up the hot face of the combustion chamber which is in contact with the combustion zone and low density insulation 60 around the outside of the higher density insulation 65. The remaining structure of the apparatus 10 is made up of segmented portions, such as the individual chequer bricks within the bed of thermal media 15, and the exterior body portions of the apparatus 10. Such a segmented construction of the apparatus 10 is able to deal with the various temperature differences that occur across the apparatus 10 during operation and allow for movement due to expansion and contraction of the materials.

In accordance with a further embodiment and regardless of the concentration of the volatile organic compounds in the gas stream being treated there it is also possible to extract heat from the outlet gas via indirect heat exchangers 70 and 71 which are placed at the end of the heat retention zone in both the first 21 and second conduits 22 before the induce draft fan 12 shown in FIG. 1. These low temperature indirect heat exchangers 70 and 71 may be placed at any point in the lower half of thermal media 15, 16. The placement height of the indirect heat exchangers 70 and 71 is determined by the temperature of the heat that is required to be removed from the heat retention zone.

In certain embodiments, hot oil can be used as a heat exchange medium to extract heat at between 100 to 120° C. which does not provide much impact on combustion chamber temperature or on the pre heating zone once the gas stream is reversed through the apparatus 10. The heat exchange medium only flows through the heat exchangers 70 and 71 when they are located in the heat retention zone depending on the direction of the flow of the gas stream through the apparatus. Therefore in a gas flow direction when the gas stream is introduced into the first conduit 21 of the apparatus 10, the heat exchange medium in heat exchanger 70 would not flow and the heat exchange medium in heat exchanger 71 would flow thereby only removing heat from the heat retention zone which is in the second conduit 22.

In the event that the apparatus is treating a gas stream with a high concentration of methane or VOC, then the indirect heat exchangers 70 and 71 could be placed towards the combustion zone within the bed of thermal media 15, 16 to recover higher temperature heat. If the methane or VOC concentration was lower, then the indirect heat exchanger would be placed towards the outlet within the thermal media 15, 16 to recover low temperature heat as specifically shown in FIG. 2.

Prior to using the apparatus 10 to remove a volatile organic compound from a gas stream, the apparatus 10 needs to be pre heated such that the combustion zone reaches the required temperature for the combustion of the volatile organic compound to occur within the combustion zone. If we take the example of VAM, the combustion zone must be heated to at least 595° C. for this to occur. This can be accomplished through a variety of means such as by running a supply of waste heat, such as from an exhaust of a gas engine, through the apparatus in order to pre heat the pre heating zone, and to begin to heat the combustion zone. In addition, the gas gun 40, the additional burner 45 and the steam tubes 65 may all be used individually or in combination in order to heat up the combustion chamber to the desired level.

Once preheated, the VAM is then introduced into the inlet 17 of the first conduit 21 which contains the bed of thermal media 15 that makes up the pre heating zone. Here the VAM is heated up as it passes through the chequer bricks and ideally the temperature of the VAM reaches above 595° C. by the time the VAM reaches the top 25% of the chequer bricks 20. At this point the methane within the VAM begins to combust as the VAM passes through the last portion of the pre heating zone into the combustion zone within the combustion chamber 35. Within the combustion zone, the remainder of the methane is combusted and the temperature within the combustion chamber is controlled such that it doesn't drop below 700° C. and does not reach above 1200° C. Such control can be accomplished by determining the temperature of the combustion zone and providing more heat via the gas gun 40, or the burner 45 or a combination of both, or alternatively, removing heat from the combustion zone by increasing the level of indirect heat exchange from the steam tubes 46 or by venting some of the excess heat via the vent 50 or increased heat removal on the lower heat exchangers 70 and 71.

Once the VAM has passed through the combustion zone and the methane content has been substantially removed from the gas stream the resulting exhaust gas which is still at a high temperature is introduced into the inlet 27 of the second conduit 22 where the exhaust gas passes through the bed of thermal media 15 that forms the heat retention zone. As this hot gas passes through the chequer bricks making up the bed of thermal media 15, the heat of the gas is transferred into and retained by the chequer bricks by direct heat exchange and the exhaust gas gradually cooled. Over time, this results in the heat retention zone heating to a temperature sufficient whereby it can act as the pre heating zone of the apparatus.

Once a certain period of time has passed which in this embodiment is a 30 minute period, the first valve inlet 13 directing the flow of the VAM to the apparatus 10 into the first conduit 21 closes and second valve inlet 14 opens thereby redirecting the flow of the VAM into the outlet 18 of the of the second conduit 22, with the exhaust gas then exiting from the apparatus out of the first valve outlet (not shown in FIG. 2 but is opposite the first valve inlet) of the first conduit 21 which then exists the apparatus 10. When reversed, the second conduit 22 containing the bed of thermal media then begins to act as the pre heating zone and heating the YAM prior to introduction into the combustion chamber 35. The exhaust gas then passing from the combustion zone into the outlet 26 of the first conduit 21 passes through the thermal media 15 within the first conduit 21 making up the heat retention zone which then gradually increases the heat of the heat retention zone via direct heat exchange. The hot exhaust gas now free of methane exits the heat retention zone and may be vented to atmosphere or used for another purpose.

After another 30 minutes in the second gas flow direction, the valve arrangement then redirects the flow of the VAM again introducing the flow into first valve inlet 13 of the first conduit 21 of the apparatus 10. The redirection forming first and second flow directions which are alternatively cycled for heat efficiencies whereby the apparatus 10 operates in a similar fashion to a regenerative burner.

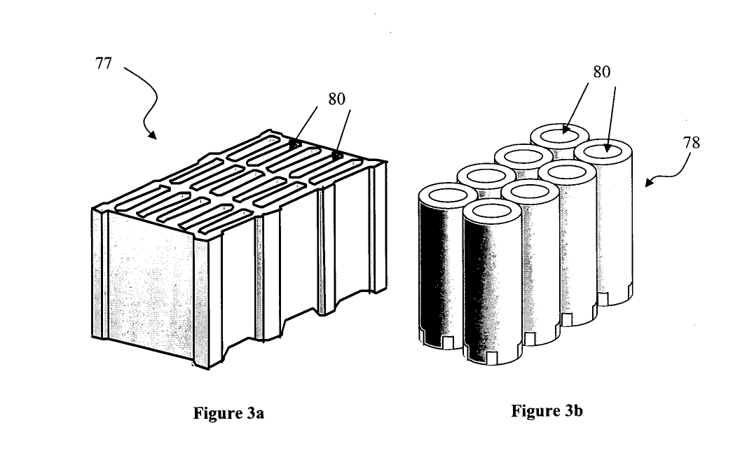

Referring now to FIG. 3 there are shown two examples of chequer bricks 77, 78 that may be used in accordance with the present invention that when stacked on top of each other form the thermal media 15. The chequer bricks 77, 78 may be of any particular shape. These shapes can include but are not limited to quadrilateral, circular, hexagonal or octagonal shapes. The shape of the chequer brick may be any shape that provides a chequer brick with high density and high void space necessary to minimise pressure drop whilst maintaining high thermal mass, which equates to heat storage. It is highly preferred that the chequer bricks include passages 80 passing through the chequer bricks which increase the void space of the chequer brick and permit a gas stream to pass through them without significant pressure drop.

According to one embodiment, the chequer bricks included in the pre heating and/or heat retention zones have a bulk density greater than 1.5 t/m³, and preferably greater than 2.0 t/m³. It is also advantageous that the chequer bricks have a shape that enables the gas stream to pass through the preheating zone and/or heat retention zone without significant pressure drop. This may be provided with a chequer brick with a large amount of void space, such as greater than 30% volume void space, or preferably greater than 50% void space.

According to one embodiment of the present invention, the top 10% and preferably the top 25% of the chequer bricks within the pre heating zone and/or the heat retention zone which are adjacent the combustion zone are composed of high alumina bricks whilst the bottom 75% are composed of a high density fireclay brick because of their cheaper price and thermal cycling robustness. A high alumina brick equal to or greater than 48% Al₂O₃ may be used for the top chequer bricks adjacent the combustion zone due to their resistance to fluxing and thermal deformation. A high density fire clay brick with between 38 to 44% Al₂O₃ may be used in the bottom 80% of the pre heating of heat retention zone.

According to another embodiment, the height of the checker bricks within the pre heating and heat retention zones is at least 2.0 metres in length and in a preferred form at least 3.0 metres in length. The length of the pre heating and/or heat retention zones composed of the checker bricks provides a flame path barrier between the combustion zone and the mine ventilation air inlet. The chequer bricks may act in this form as a flame arrestor. The elimination of flame arrestors in such an apparatus reduces pressure drop and reduces the necessity of regular maintenance.

In one embodiment, the thermal mass of the chequer bricks is equal to or greater than 4 tonne per in³/s of gas stream entering the inlet of the pre heating zone where the chequer bricks have a heat capacity equal to or greater than 1.3 kJ/kg/° C.

In one embodiment and as shown in FIG. 2, the first 21 and second 22 conduits including the pre heating zone and the heat retention zone may be positioned adjacent one another with the combustion chamber 35 including the combustion zone at one end of the pre heating and heat retention conduits and the inlet for the mine ventilation air and the outlet for the exhaust gases at the other end of the apparatus. Such an arrangement provides that heat may be transferred between a common wall between the pre heating zone and the heat retention zone. This arrangement also facilitates modular construction from factory built panels, reducing cost of the apparatus and improving refractory cast quality. In this form, the first 21 and second 22 conduits are orthogonal in cross section.

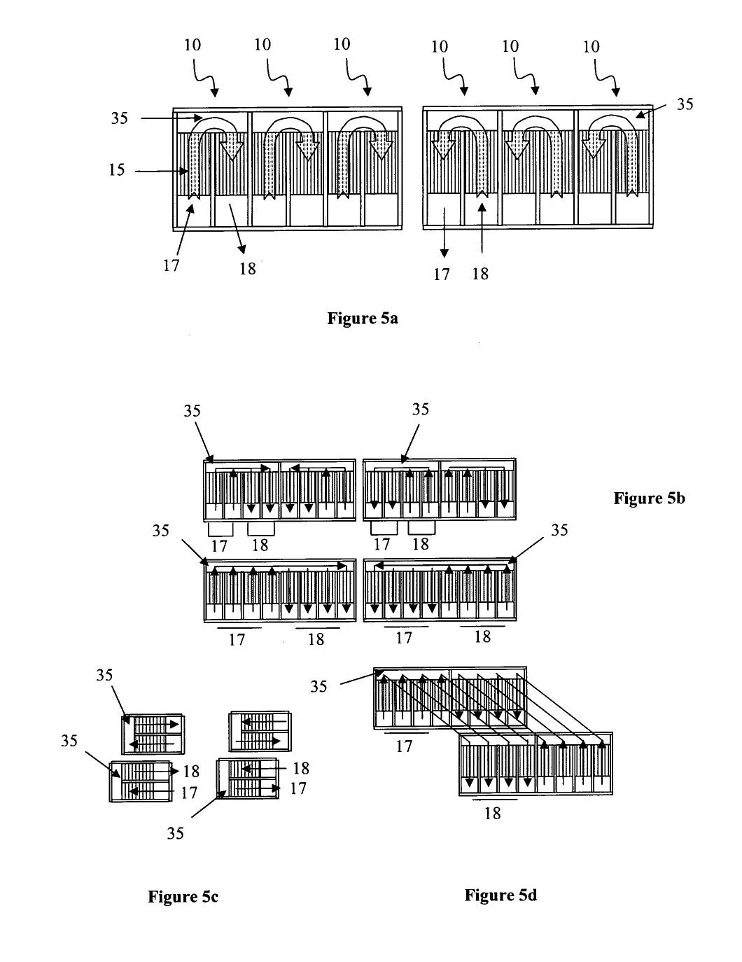

Referring now to the various arrangements outlined in FIG. 5, the combustion chamber 35 including the combustion zone is arranged at the opposite end to where the inlet 17 and outlet 18 of the first and second conduits where the introduction of the VAM enters the pre heating zone and where the warm exhaust gas exits the heat retention zone. Such an arrangement provides that the combustion chamber 35 may include a vent which is able to vent excess heat within the combustion chamber to atmosphere. This arrangement may be easily obtained if the combustion chamber 35 is at one end of the apparatus and not in the middle of the apparatus.

As can be seen from FIG. 5, in certain embodiments more than one apparatus may be arranged in series with the conduits including the pre heating/heat retention zones aligned next to each other. In such an arrangement, various flow patterns between the different apparatus may be obtained and the adjacent combustion chambers 35 may or may not be linked.

As can be seen from FIG. 5, each apparatus 10, or unit, in accordance with the invention may be grouped into a pack such that each unit shares at least one common wall with another unit. This minimises heat loss between the units and also allows control of individual combustion chambers 35 to cater for the differences in heat lost between the centre unit and those at the end of the pack. A group of apparatus 10 or units may be packed or grouped into a battery. This allows extra capacity to be incorporated in a design without needing a complete new design for each particular application, such as at a different mine site with different quantities of VAM.

In accordance with one embodiment of the present invention, the combustion chamber may have one or more additional heat inputs. Such heat inputs may be chosen from sources such as, waste heat including gas engine exhaust, a gun fired low CV fuel gas burnt within the combustion chamber and/or a high CV gas burner that may also be used within the combustion chamber to bring the chamber up to the required temperature to oxidise the low concentration methane within the ventilation air stream.

Before the method and/or apparatus of the present invention may begin to remove methane from the gas stream, the pre heating zone and/or combustion zone is required to be heated to an operational temperature. In order to achieve the initialing heat up to operational temperature, gas engine exhaust at 450 to 500° C. may be used to heat the pre heating zone and the combustion zone by sucking the exhaust into the gas stream inlet into the pre heating zone conduit and then into the combustion zone. Alternatively, a package burn may be used for the initial heat source up to operational temperature.

The extra temperature then needed in the combustion chamber may be obtained via a small external burner fired by high quality coal seam methane or LPG. Once the combustion chamber is above 700° C., low grade coal seam methane can be added to the gas gun to raise the combustion chamber to a working temperature. This method of heat up reduces the size of the required burners and utilises existing waste heat that is often on coal mining sites. A gas gun style heating also allows the use of variable quality coal seam methane without the difficulty of a burner blowing out due to poor stoichiometry. A gas gun also ensures pre heating of the low quality fuel gas so that complete burnout in the combustion chamber is ensured.

In another embodiment, heat extraction coils may be located within the combustion chamber which remove heat by indirect heat exchange which then avoids over heating within the combustion chamber. This ensures that the heat captured is at sufficient temperature that it can be converted to electricity at a reasonable efficiency. It also ensures that the combustion chamber and top layer of chequer bricks do not have enough heat to allow solid state migration of CaO into the refractory matrix and thereby flux the refractory. The combustion zone temperature should be kept below 1200° C. to ensure this and more preferable below 1150° C. to allow for normal fluctuations in temperature that can occur.

A pressure relief panel is also provided in the combustion chamber which is able to progressively open to vent hot air to atmosphere above once the temperature within the combustion zone reaches above 1100° C. Additionally, this panel can open further at any time during the method to avoid over pressure should a pocket of methane rich air enters the combustion chamber as can be seen from FIG. 4.

In accordance with one embodiment, the apparatus of the present invention may be constructed from pre-fabricated panels which are tilted into place. This may be done to reduce site costs and to improve the panel quality. Panels that have been cast horizontally have less distance to the top of the cast to remove air bubbles and less density difference between the two sides. The smother, denser and more dimensionally accurate side goes to the inside of the unit. Some panels are made from different materials with different refractory characteristics to produce a hot face and insulation layers.

The pre-fabricated tilt built structure may be supported by external steel work and tie rods which run through the pre-fabricated panels. This keeps joints tight and allows for refractory expansion and contraction. The refractory panels are always kept in compression by spring loads on the tie rods to minimise cracks from thermal cycling.

To reduce cost the apparatus uses a modular design wherein the apparatus may be constructed from factory built panels.

In certain embodiments, the direction of the flow of the gas stream may be redirected from the inlet of the pre heating zone to the outlet of the heat retention zone at time intervals of equal to or greater than 30 minutes. Such a time period for redirecting the flow is possible with a significant thermal mass provided by the large amount of thermal media that makes up the pre heating and heat retention zones. The reversal mechanism having a low frequency of cycling reduces maintenance and idle time during the reversal of the flow direction of the gas stream.

In accordance with a further embodiment, the cross sectional area of the first and second conduits may be equal to or greater than 0.5 m² per m³/s of VAM. This ensures the pressure drop across the thermal media is low, which reduces fan power costs.

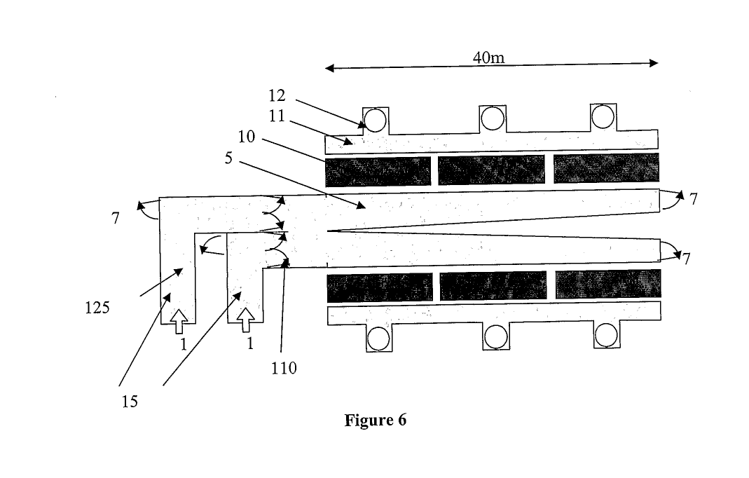

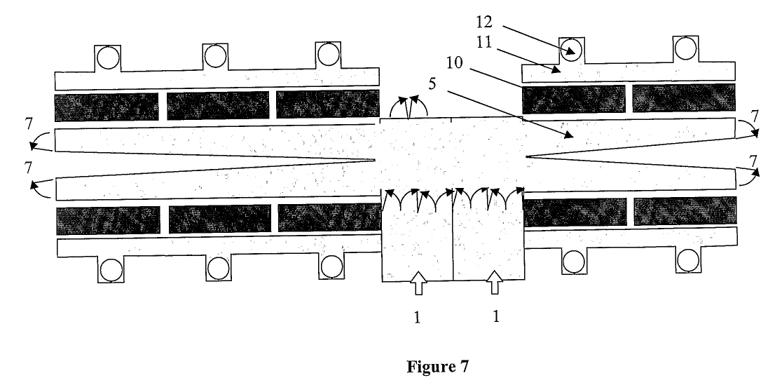

In accordance with a further embodiment and referring to FIGS. 6 and 7, an arrangement is shown which includes two fans 1 leading from a mine shaft ventilation system which produce a gas stream of VAM and introduce this into a conditioning duct 5 where the gas stream may be partially heated and/or wherein particulate matter may be removed from the gas stream. The conditioning duct 5 is aligned horizontally such that any particulate matter that falls out of the gas stream falls to the floor of the conditioning duct 5. The conditioning duct 5 is at least 15 metres in length, and in a preferred form at least 20 metres in length and may be composed of concrete or insulated sandwich panel members.

The conditioning duct 5 may also be heated by indirect heat exchange which in turn provides heat to the gas stream passing through the conditioning duct before entering into the apparatus 10. The conditioning duct 5 may be heated by indirect heat exchange and this may be provided by heat taken from the combustion zone via a separate circuit of steam tubes 46 or low temperature circuits of 70 and 71.

By having a large cross-sectional area duct 5 prior to the unit or apparatus 10 of the present invention where the gas stream velocity is reduced below 7 m/s, preferably below 3 m/s, to act as a mud drop out zone 125 such as depicted in FIG. 4. This duct is made of concrete and or insulated sandwich panel and is preferably over 15 m long and frangible design.

The mine ventilation air is conditioned though the large concrete ducts 5 by slowing the gas flow down so the dust falls to the fall and the gas is heated.

Once passing through the conditioning duct, the VAM passes into the apparatus 10 and where the methane content is combusted in the combustion zone of the apparatus 10. The gas stream then passes out to the clean air side 11 of the apparatus via the valve arrangement and is then sent to the stacks 12 which vent the gas stream to atmosphere.

This apparatus and method of the present invention can cope with both high and low methane content within coal mine ventilation air, within normal daily operation without modification. It copes with dust, and more significantly lime dust, and has a low pressure drop. It is also lower cost whilst being more functional than current flow reversal oxidisers.

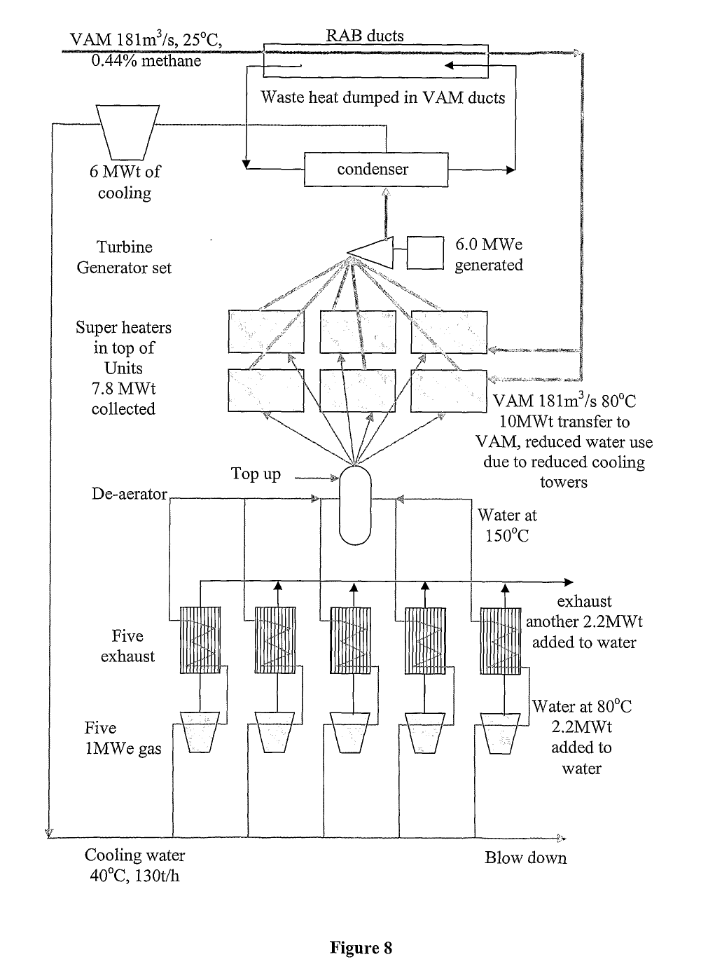

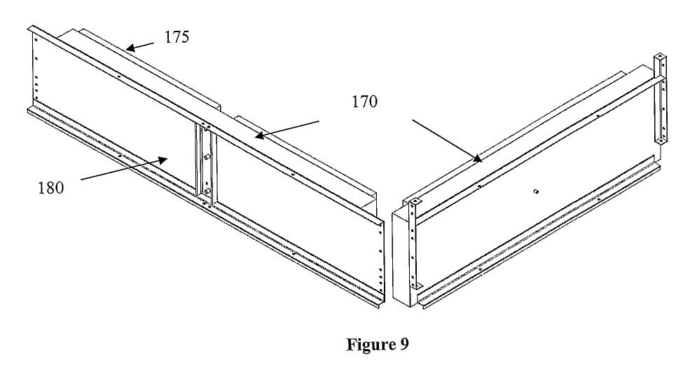

FIG. 8 is a process diagram depicting the incorporation of the apparatus of the present invention indicated by RAB on a coal mine site which includes gas engines producing electricity from gas reserves.

Referring to FIG. 9 the detail of the construction of the composite panels that make up the apparatus is shown in accordance with certain embodiments. An initial layer of insulating hot face refractory 175 is the material which faces into the combustion chamber or thermal media of the apparatus. This is then followed by a middle insulating refractory layer 170 and then finally an outside layer of steel shell 180.

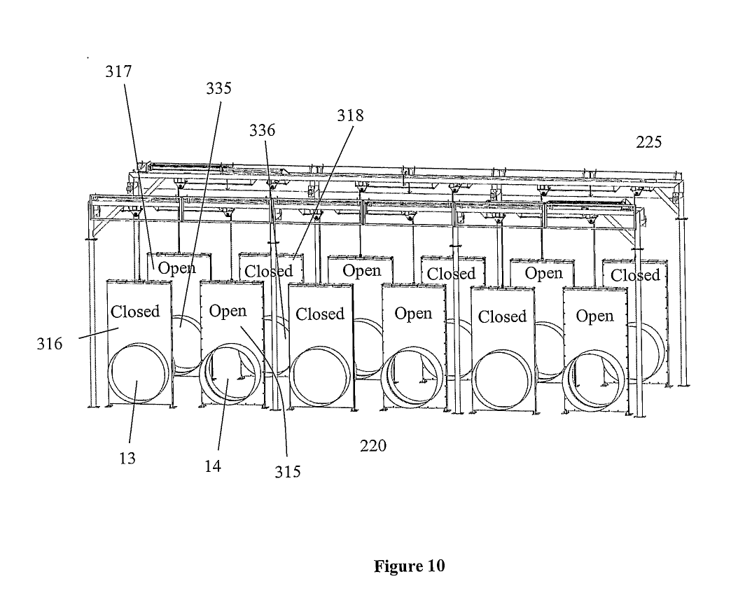

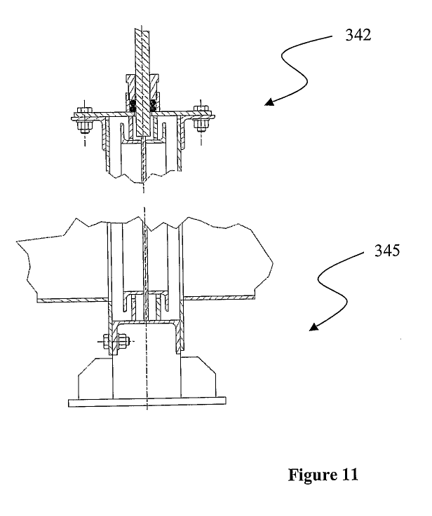

Referring to FIG. 10 there is shown a representation of a valve assembly for a battery of apparatuses in accordance with certain embodiments. The directing chambers of the of the first and second conduits of the valve arrangement (not shown) each include an inlet 13, 14 for receiving a gas stream from the VAM side 220 and an outlet 335, 336 for distributing the gas stream once treated in the apparatus to the clean air side 225. The inlets of the valve arrange 13, 14 each include a valve closure 316, 315 and each of the outlets 335, 336 of the valve arrangement each include a valve closure 317, 318. The valve closures 316, 315, 317, 318 are each moveable between an open position where a gas stream may pass through and a closed position where a gas stream is prevented from flowing through. In this embodiment the valve closures 316, 315, 317, 318 are gate valves.

The valve assembly is capable of directing the flow of VAM into the apparatus in two distinct flow directions, i.e. a first flow direction and a second flow direction. During the first flow direction the inlet 13 of the first directing chamber is in an open state and the outlet 335 of the first directing chamber is in a closed state, and the inlet of the second directing chamber 14 is in a closed state and the outlet of the second directing chamber is in an open state 336. This provides that during the first flow direction, the gas stream containing the one or more volatile organic compounds is received by the inlet 13 of the of the first directing chamber which then flows into the inlet of the first conduit passing though the apparatus and exiting through outlet of the second conduit into the second directing chamber where the gas stream is directed out of the outlet 336 of the second directing chamber.

During the second flow direction (as specifically shown in FIG. 10) the inlet 13 of the first directing chamber is in a closed state and the outlet 335 of the first directing chamber is in a open state, and the inlet 14 of the second directing chamber is in an open state and the outlet 336 of the second directing chamber is in a closed state. This provides that during the second flow direction, the gas stream containing the one or more volatile organic compounds is received by the inlet 14 of the second directing chamber which then flows into the outlet of the second conduit passing though the apparatus and exiting through the inlet of the first conduit into the first directing chamber where the gas stream is directed out of the outlet 3358 of the first directing chamber.

Referring to FIG. 11, there is shown a detailed cross section of a gate valve in accordance with certain embodiments 342 which shows the top part of the seal surrounding the gate valve when the gate valve is in the open position. As can be seen the seal arrangement includes a labyrinth seal arrangement to significantly reduce the leakage of any gas when the gate valve is in the closed position. In addition FIG. 11 also shows the bottom of the gate valve when in the closed position 342 again depicting a labyrinth seal arrangement.

In certain embodiments, the apparatus and process may include various features which provide the present invention with the ability to cope with such an irregular concentration range of methane within the gas stream, these features include:
By pass and dilution of the gas stream including the volatile organic compound in the conditioning duct;
Pre-heating the gas stream using waste heat with indirect heat exchange circuits within the conditioning duct and thus providing a pre-heater for the gas stream;
Frangible design of conditioning duct to deliberately fail at about 5 kPa thus separating the mine from the apparatus in the instance of potentially explosive concentration of methane;
Multiple energy top up schemes that can act simultaneously for methane content below 0.2% and increase the temperature within the combustion chamber of the apparatus; these including:
   Gas engine exhaust (for the initial heat up)
   gun fired low CV fuel gas and
   a high CV gas burner
Apparatus/units being grouped in to a pack so that each unit shares at least one common wall with another unit.
High thermal mass of thermal media such as in the form of chequer bricks is equal to or greater than 4 t per m3/s of VAM where the chequers have a heat capacity of greater than 1.3 kJ/kg/° C.
A directional flow reversal time of the VAM equal to or greater than 30 minutes.

Whilst being able to cope with low methane content the apparatus and method of the present invention may also cope with high methane content by including one or more of the following features:
including heat extraction coils in each combustion chamber to avoid over heating.
having pressure relief panels to vent excess heat that is beyond the heat extraction coils ability to remove.
having thermal media that is resistant to CaO fluxing and a high refractoriness, particularly the thermal media which is close to the combustion chamber of the apparatus.
having heat extraction coils in the base of the bed of thermal media to recovery low grade heat.

In certain embodiments, the apparatus and method include various features which may eliminate the risk of explosion risk to the mine whilst still including a combustion mechanism for the elimination of volatile organic compounds such as methane. The minimisation of the explosive risk may be accomplished by various features, such as for example:
opening by pass and dilution doors on the conditioning duct
having frangible design of the conditioning duct
having the VAM in the conditioning duct significantly higher than methane flame speed
having a long length through the thermal media of, greater than 2.0 m, more preferably 3.0 m to provide a flame barrier
having one combustion chamber per apparatus. This combustion chamber is at the opposite end to where the warm VAM enters and where the warm exhaust gas exits the regenerator.
having heat recovery and high thermal mass in the combustion chamber to minimise the affects of methane concentration variability.
having pressure relief flaps to vent excess heat from the combustion chamber that is beyond the heat extraction coils. During high methane content events the combustion chamber is also open to atmosphere and the pressure in the chamber is not able to build up.
the ability to avoid over heating means that the cool end of the chequers bricks is significantly below the auto ignition temperature and thus the chequer brick quench any flash back.

The apparatus of the also eliminates significant pressure drop across the apparatus the inlet and outlet. This may be achieved by various features in certain embodiments such as for example:
having no flame arrestors other than the chequers bricks
having a Cross sectional area equal to or greater than 0.5 m² per m³/s of VAM.
having and high voidage heat transfer media
having a large cross-sectional area duct prior to the RAB where the VAM velocity is reduced below 7 m/s, preferably below 3 m/s but above 2 m/s to act as mud drop out zone.

In certain embodiments, the costs of producing the apparatus are significantly less than producing present flow reversal oxidiser, The various features which may contribute to the costs savings include the following:
Construction of the apparatus from pre-fabricated panels which are tilted into place as shown in FIG. 9.
The pre-fabricated tilt built structure is supported by external steel work and tie rods which run through the pre-fabricated panels. Therefore normal expansion and contraction does not cause cracking.
Modular design means that the battery of units can be quickly sized and built with minimum redesign for individual customers.
Temperature control avoids melting heat transfer media.
High Al₂O₃ content heat transfer media avoids fluxing and thus avoids melting.
Alternative idle hot and low methane content heating scheme that use low grade coal seam methane rather than high CV methane mixes.
A large cross-sectional area duct prior to the RAB to drop out dust, thus avoiding blockages and glazing.
A higher yield of useful energy due to pre-heating in ducts using waste heat and integration with other processes.

The present invention will become better understood from the following example of a preferred but non-limiting embodiment thereof.

### Example 1

A mine has an average air ventilation flow of 181 m3/s, which has an average methane concentration of 0.44% volume. Due to the variability of the mine operation, about one third of the time, extra energy is required to ensure good methane burn out. Assuming an average exhaust temperature of 100° C. there is 7.8 MW of waste heat.

For such a mine the ventilation air flow is delivered to an apparatus in accordance with one embodiment of the present invention in the form of two 4 m by 4 m tunnels made from insulated sandwich panel. The average velocity of the ventilation air flow is 5.6 m/s. At this speed, some mud and dust is deposited in the duct. Every six months one ventilation air fan is isolated and the idle duct is cleaned.

The air is heated to about 80° C. within the duct. In coupling gas engines which produce a large amount of low grade heat with the apparatus of the present invention which produces a small amount of high grade heat the system together is capable of producing more electricity than the sum of the two parts working independently.

The two ventilation air ducts join so that either fan can feed the inlet of the apparatus. Refer to FIG. 5. The ventilation air duct tapers to distribute the ventilation air evenly between the various units in accordance with the present invention. The are 18 units distributed as 6 packs each containing 3 units. The final shape of the battery is dependent on available land but in this example sits 40 in long. Each pack is 5 minutes out of synchronisation.

Each pack is 13 m long 3 in deep and 7.0 m high. The chequer brick pre heating and heat retention zones are 3 m in height. The ventilation air enters through a 1000 mm diameter slidegate valve to an inlet beside the pre heating zone, refer to FIG. 10, composed of the chequer bricks. The warm ventilation air passes up through the chequer bricks picking up heat from the chequers which are slowly cooling. At about 2.5 m up the chequer pack the methane within the ventilation air is starting to slowly combust. Most of the combustion occurs in the combustion zone in the combustion chamber. The gas velocity in the combustion chamber is kept above the particle settling velocity.

The temperature in the combustion chamber is kept below 1100° C. by a steam cooled heat exchanger in the top of the combustion chamber as can be seen from FIG. 2. The temperature is kept above 850° C. by reducing the steam flow through the heat exchanger. To keep the temperature above 750° C. coal seam gas is added to the gas gun. The gas gun is used whenever the combustion chamber is hotter than 700° C. To heat the combustion chamber from cold to working temperature a small external burner is used in each unit.

The benefit of a gas gun is that it can use low grade coal seam gas; for example, the addition of a mixture of 30% methane which only has a CV of 11.1 MJ/Nm3.

This example represents a net drop in green house gas of 319,253 tpa of CO₂ equivalent not including the benefit of power generation.

### Example 2

A mine has an average air ventilation flow of 277 m3/s and average 0.73% methane. Assuming an average exhaust temperature of 165° C. there is 20.7 MW of waste heat. About 5.1 MWe of power is generated from waste heat. Due to variability of the mine operation, about one third of the time, the amount of waste heat exceeds the power stations capacity to use this heat.

For such a mine the ventilation air is delivered to the an apparatus in accordance with the present invention is in two 4 m by 8 m tunnels made from tilt built concrete. The average ventilation air velocity is 4.3 m/s.

The two ventilation air ducts join so that either fan can feed the apparatus battery (as shown in the embodiment in FIG. 7). The ventilation air duct tapers to distribute the ventilation air evenly between packs. There are 30 units distributed as 10 packs each containing 3 units. The final shape of the battery is dependent on available land, but in this example sits 64 m long. Each unit pack is 3 minutes out of synchronisation.

This example represents a net drop in green house gas of 803,834 tpa of CO₂ equivalent.

The invention has been described by way of non-limiting examples only and many modifications and variations may be made thereto without departing from the spirit and scope of the invention described.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. An apparatus for removing one or more volatile organic compounds from a gas stream, the apparatus including:
a first conduit containing thermal media forming a pre heating zone, the first conduit including an inlet at one end for introducing the gas stream into the pre heating zone and an outlet at the other end of the first conduit, wherein the pre heating zone increases the temperature of the gas stream via heat transfer; and,
a combustion chamber forming a combustion zone wherein the combustion chamber is in fluid connection with the outlet of the first conduit for receiving the gas stream exiting the pre heating zone,
wherein the combustion zone is at a temperature sufficient whereby at least one of the volatile organic compounds in the gas stream combusts.

2. An apparatus according to claim 1 wherein the apparatus further includes a second conduit containing thermal media forming a heat retention zone including an inlet at one end for receiving the gas stream after passing through the combustion zone, wherein the gas stream received by the inlet of the second conduit increases the temperature of the heat retention zone via heat transfer, the second conduit further including an outlet at the other end.

3. An apparatus according to claim 1 wherein the pre heating zone containing the thermal media is of a sufficient length whereby the pre heating zone provides a flame path barrier between the combustion zone and the inlet of the first conduit.

4. An apparatus according to claim 3 wherein the pre heating zone is at least 2 m in length.

5. An apparatus according to claim 2 wherein the length of the heat retention zone containing the thermal media is the same or substantially the same length as the pre heating zone.

6. An apparatus according to claim 1 wherein the thermal media is composed of a material with a bulk density greater than 1.5 t/m³.

7. An apparatus according to claim 1 wherein the thermal media is composed of a material with a sufficient void space whereby there is no substantial drop in pressure between the gas stream entering the pre heating zone and the gas stream entering the combustion zone.

8. An apparatus according to claim 1 wherein the thermal media is composed of a material with a void space of greater than 20% volume.

9. An apparatus according to claim 1 wherein the thermal media is composed of a material that has a refractory softening temperature of greater than 1400° C.

10. An apparatus according to claim 1 wherein the thermal media is composed of a material that includes at least 30% weight Al₂O₃.

11. An apparatus according to claim 1 wherein the thermal media within the pre heating zone, and/or the heat retention zone, and adjacent the combustion zone are composed of a material that includes at least 44% weight Al₂O₃.

12. An apparatus according to claim 11 wherein the thermal medial adjacent the combustion zone includes at least 10% of the total thermal media within the pre heating zone and/or the heat retention zone.

13. An apparatus according to claim 1 wherein the thermal media is composed of a plurality of chequer bricks that are stacked along the length of the pre heating zone and/or heat retention zone.

14. An apparatus according to claim 1 wherein the pre heating zone may be initially heated be passing a hot gas stream through the pre heating zone to heat the pre heating zone to a desired temperature before introducing the gas stream including the one or more volatile organic compounds.

15. An apparatus according to claim 1 wherein the combustion zone includes an additional heat source to bring the combustion zone to the desired temperature where at least one of the volatile inorganic compounds in the gas stream begin to combust.

16. An apparatus according to claim 1 wherein the temperature of the combustion zone may be adjusted by indirect heat exchange with a separate circuit of heat exchange medium.

17. An apparatus according to claim 1 wherein the combustion chamber includes one or more vents moveable between a closed position and an open position wherein the temperature within the combustion zone may be reduced by opening the one or more vents and allowing heat to escape from the combustion zone through the one or more vents.

18. An apparatus according to claim 1 wherein the heat retained in the heat retention zone may be recovered by indirect heat exchange with a separate circuit of heat exchange medium.

19. An apparatus according to claim 1 wherein prior to the gas stream including one or more volatile organic compounds is introduced into the pre heating zone, the gas stream passes through a conditioning duct where the gas stream may be partially heated and/or wherein particulate matter may be removed from the gas stream.

20. An apparatus according to claim 19 wherein the conditioning duct is aligned horizontally prior to the inlet of the first conduit such that any particulate matter that falls out of the gas stream falls to a bottom surface of the conditioning duct.

21. An apparatus according to claim 19 wherein the conditioning duct is at least 10 metres in length.

22. An apparatus according to claim 19 wherein the conditioning duct includes one or more safety doors which are able to move between an open and closed position wherein the gas stream passing along the conditioning duct is able to be expelled to atmosphere when the one or more safety doors is in the open position.

23. An apparatus according to claim 22 wherein the one or more safety doors opens when a fraction of the lower explosive limit value for at least one of the volatile organic chemicals is detected in the gas stream passing through the conditioning duct.

24. An apparatus according to claim 2 further including a valve arrangement capable of changing the direction of the flow of the gas stream to the apparatus between a first flow direction and a second flow direction whereby in the first flow direction the valve arrangement introduces the gas stream including the one or more volatile organic compounds into the inlet of the first conduit; and whereby in the second flow direction the gas stream including the one or more volatile organic compounds is introduced into the second conduit whereby the heat retention zone becomes the pre heating zone of the apparatus and the pre heating zone becomes the heat retention zone of the apparatus.

25. An apparatus according to claim 24 wherein the valve arrangement redirects the flow of the gas stream between the first flow direction and the second flow direction once the heat retention zone reaches a predetermined temperature condition resulting from the heat provided from the gas stream passing through the heat retention zone after the combustion zone, and/or after a pre determined time interval.

26. An apparatus according to claim 24 wherein the redirection of the gas stream between the first flow direction and the second flow direction is conducted cyclically.

27. An apparatus according to claim 24 wherein the valve arrangement includes two directing chambers with a first directing chamber in fluid communication with the inlet of the first conduit, and a second directing chamber in fluid communication with the outlet of the second conduit, wherein each of the directing chambers includes an inlet for receiving the gas stream including the one or more volatile organic compounds, and an outlet for receiving the gas stream after the at least one volatile organic compounds has been combusted in the combustion zone, wherein each of the inlets and outlets of the first and second directing chambers are individually moveable between an open and a closed state by a respective valve closure.

28. An apparatus according to claim 27 wherein each of the valve closures is a gate valve.

29. An apparatus according to claim 28 wherein the gat valve includes a labyrinth seal arrangement.

30. An apparatus according to claim 27 wherein during the first flow direction the inlet of the first directing chamber is in an open state and the outlet of the first directing chamber is in a closed state, and the inlet of the second directing chamber is in a closed state and the outlet of the second directing chamber is in an open state.

31. An apparatus according to claim 27 wherein during the second flow direction the inlet of the first directing chamber is in an closed state and the outlet of the first directing chamber is in a open state, and the inlet of the second directing chamber is in an open state and the outlet of the second directing chamber is in a closed state.

32. An apparatus according to claim 2 wherein the first conduit including the pre heating zone and the second conduit including the heat retention zone are arranged side by side with the combustion chamber at one end in fluid communication with the outlet of the first conduit and the inlet of the second conduit.

33. An apparatus according to claim 2 wherein one or more apparatus may be arranged side by side to form a battery of apparatuses wherein the pre heating zones and the heat retention zones of the apparatuses may be arranged side by side to increase the thermal efficiency of the battery of apparatuses.

34. An apparatus according to claim 1 wherein at least one of the volatile organic compounds in the gas stream is methane.

35. An apparatus according to claim 34 wherein the concentration of methane in the gas stream is less than about 5% volume.

36. An apparatus according to claim 34 wherein the concentration of methane in the gas stream varies periodically.

37. An apparatus according to claim 1 wherein the gas stream including the volatile organic compound is a gas stream exiting from a mine ventilation system.

38. An apparatus according to claim 37 wherein the mine ventilation system is associated with an underground coal mine.

39. A process for removing one or more volatile organic compounds from a gas stream, the process including the following steps:
a. passing the gas stream through a pre heating zone wherein the pre heating zone is composed of thermal media contained within a first conduit; and,
b. introducing the gas stream exiting the pre heating zone into a combustion zone wherein at least one of the volatile organic compounds included in the gas stream is combusted.

40. A process according to claim 39 wherein the gas stream exiting the combustion zone in step b. passes through a heat retention zone wherein the heat retention zone is composed of thermal media contained within a second conduit.
